(19) United States
(12) Patent Application Publication
(10) Pub. No.: US 2003/0065626 A1
(43) Pub. Date: Apr. 3, 2003

(54) User verification for conducting health-related transactions

(76) Inventor: Karl H. Allen, Portland, OR (US)

Correspondence Address: James Y. Go, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/967,211

(22) Filed: Sep. 28, 2001

(51) Int. Cl. G06F 17/60

(52) U.S. Cl. 705/76; 705/75; 705/2; 705/3

(57) ABSTRACT

The present invention provides for biometric authentication of a user's identity and credential verification in performing a health-related transaction from a portable healthcare device. An access server is employed to receive a request for a transaction and biometric data from a user. The access server determines if the submitted biometric data is that of the claimed user. Where the user identity is confirmed, the access server determines validity of credential information associated with a user, such as by request that a credential service perform a credential check. If the credential information is appropriate for the user to conduct the transaction, the access server transfers enabling information to the portable healthcare device to permit the transaction to occur. The transaction is performed via an end-to-end communication system that includes a real-time communication channel between the portable healthcare device and a remote information site. In addition, other aspects of the present invention relating to the verification of a user in a health-related transaction are also described.

### FIELD OF THE INVENTION

The present invention relates generally to the verification of the identity and credentials of a user for performing health-related electronic transactions. In particular, this invention is related to biometric authentication and credential confirmation of a user of a portable healthcare device for conducting real-time health-related transactions across a network.

### BACKGROUND

There are growing uses for handheld devices in conducting health-related transactions that involve exchanges of electronic information across a network. Health professionals, such as physicians, medical staff, dentists, chiropractors, physical therapists, pharmacists, clinical trial specialists, biomedical researchers, health plan administrators, public health officials, etc., may use handheld devices in performing their daily workflow. Many of these tasks, such as writing prescriptions, checking laboratory results, dictating information and capturing charges are best performed as a patient is being cared for, i.e. at the point of care. However, real-time performance of these tasks is often not feasible with current communication systems because several parties must participate in the transactions. In addition, immediate transactions often require concurrent communication with and access to health information that is kept at a site located across a network. Present health communication systems do not provide convenient interaction between handheld devices and such remote sites on a real-time basis.

One impediment in health systems communicating with remote sites is a growing level of trepidation over security of handheld devices. In health networking it is especially important that a user is determined to be authenticated and to be legally permitted to perform a service. There is also concern about maintaining privacy in health information connected with electronic information exchange. Some government regulations including federal and state laws, limit non-consensual use and release of private health information. Improper use or disclosure of personal health information may result in criminal and/or civil sanctions. As a result, many remote sites that retain health information, such as health planners, providers, and clearinghouses require credential information from users to safeguard the privacy of sensitive health information and to verify authorization to perform a transaction.

Credential services are available to retain credential information and/or confirm that a person or entity is entitled to perform a particular health-related transaction. For example, a credential service may determine that a healthcare professional has the proper licensing to perform the transaction, the license is current, there are no disciplinary actions restricting the professional, a professional has obtained necessary board certifications for a specialty area, general background credentials, such as professional school attended and residence training, etc.

With current systems, verification of credential information creates a significant delay in the course of health-related transaction. Usually, a remote information site receives a request for a transaction from a user and then queries a credential service for credential verification and waits for a response prior to fulfilling the request. This holdup is also coupled with slow batch off-line transfer of data between the remote site and a healthcare professional, where the data is processed at each segment of the network pathway according to its place in queue. Thus, more time is wasted as the data waits in turn to be processed and passed through the pathway. Furthermore, data generated at a handheld device is usually first transferred to a computer, such as through a docking system, where the data remains until the computer picks up the data and transfers it. Consequently, there presents considerable postponement in providing health services.

Moreover, the use of a credential service alone may not verify that a user of a handheld device is whom that person purports. Instead, authentication is commonly performed through the use of logon passwords where knowledge of the password is assumed to guarantee that the user is authentic. However, passwords can often be stolen, accidentally revealed, or forgotten. In addition, logon verification does not reconfirm the user's identity for each of multiple transactions performed during a single session. For at least these reasons, health-related transactions across a network require a more stringent authentication process.

In general, the shortcomings of the currently available methods for performing electronic health transactions are inadequate for verifying a proper user for real-time transactions through a network. In particular, previous methods do not conveniently permit immediate authentication of a user and check of credential information associated with a user and transaction.

### BRIEF DESCRIPTION OF THE DRAWINGS

The present invention is illustrated by way of example, and not limitation, in the figures of the accompanying drawings in which:

FIG. 1 is a block diagram illustrating one embodiment of a health information system having a user system that communicates with one or more remote sites, in accordance with the teachings presented herein.

FIG. 2 is a block diagram example of a portable healthcare device to request and perform a health-related transaction, in accordance with the teachings presented herein.

FIG. 3 is a block diagram example of an access server to process requests from the portable healthcare device, in accordance with the teachings presented herein.

FIGS. 4A and 4B are an illustrations of exemplary access server databases, wherein FIG. 4A shows one biometric database for storing biometric data and FIG. 4B shows one credential database for storing credential information.

FIGS. 5A, 5B and 5C are flow charts depicting user verification methods, wherein FIG. 5A shows biometric authorization and credential verification, FIG. 5B shows assessment at login and FIG. 5C shows assessment during a session, in accordance with the teachings presented herein.

FIG. 6 is a block diagram of a machine-accessible medium storing executable code and/or other data to provide one or a combination of mechanisms to control health-related transactions, in accordance with one embodiment of the present invention.

### DETAILED DESCRIPTION

The present invention provides for biometric authentication of a user's identity and credential verification in performing a health-related transaction in real-time from a wireless portable healthcare device. An access server is employed to receive a request for a transaction and biometric data from a user. The access server determines if the submitted biometric data is that of the claimed user. Where the user identity is confirmed, the access server also determines validity of credential information associated with the user, e.g. with the assistance of a credential service. If the credential information is appropriate for the user to conduct the transaction, the access server transfers enabling information, e.g. digital credential, to the portable healthcare device to permit the transaction to occur.

The transaction is performed via an end-to-end communication system that includes a real-time communication channel having wired and wireless segments between the portable healthcare device and a remote information site. For such real-time processing, a request for a transaction and a transaction are acted upon immediately by all segments responsible for resolving the request or transaction as the request or transaction is pushed toward resolution, no matter where the segment is located in the network. This real-time process is distinct from prior systems places requests or transactions in queue for later or batched processing. As a result of the present health information system, the healthcare professional experiences resolution of the request or transaction while the professional still in the moment of attending to the request, which timing meets with the healthcare professional's expectation of when the process should be completed. Different requests or transactions may take varying times to perform. For example, the real-time process may take a several seconds, e.g. 10 seconds, or less.

A user of the portable healthcare device may be any individual who is a health professional, such as a healthcare provider, e.g. a provider of medical or health-related services and any other person or organization that furnishes, bills, or is paid for healthcare services or supplies in the normal course of business. There may be one or more than one user of a single portable healthcare device, where each user submits its own biometric data into the system and is associated with its own credential information.

There are numerous health-related transactions with remote sites that may be facilitated by use of a portable healthcare device. The health-related transactions involve exchange of any health-related information, e.g. pertaining to a subject's health, wellbeing, or makeup, that has potential for being useful to a user of the portable healthcare device or to the remote information site. Some transactions with the portable healthcare device include “e-prescribing” services to write and electronically route prescription orders and renewal prescriptions to remote pharmacy sites, including retail, online or mail order pharmacies. In addition, claims may be submitted online via a portable healthcare device to remote payer sites, e.g. Pharmacy Benefit Managers (PBM's), which manage the process of health insurance companies paying for prescriptions. Such health information exchanged through the use of a portable healthcare device may result in increased formulary compliance, resulting in PBM's receiving higher margins for filling drugs based on formularies. There may also be improved drug compliance where certain prescription history information is transferred, such as whether a patient had filled a new prescription or whether a patient had received a refill within the prescribed time. Still other, electronic transactions may be related to lab services, i.e. e-lab services with a testing site. The remote sites often require certain enabling information from the portable healthcare device for a transaction. The access server may provide such enabling information to the portable healthcare device where the user is verified.

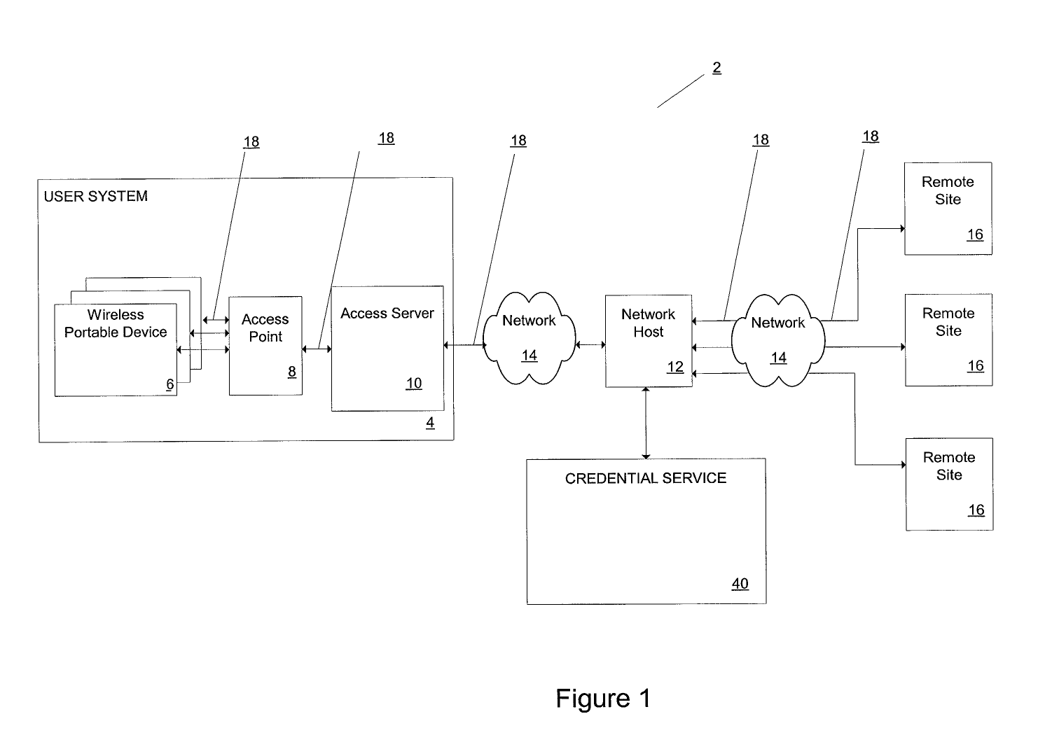

FIG. 1 illustrates an embodiment of an integrated health information system 2 having various segments along a network pathway 18 and communication with a credential service 40 to exchange credential information related to users of the portable healthcare device. The network pathway 18 is an open network channel that provides a constant connection of the segments of the pathway so that health-related information may continually flow through the segments between any given portable healthcare device and a select remote information site. A user system 4 communicates with the credential service 40 through the network host 12. The user system also communicates with one or more remote information sites 16 through an external network 14 and along the network pathway 18, according to the present invention. Within the user system 4, at least one portable healthcare device 6 is to communicate with an access server 10 often through one or more wireless access points 8 along the network pathway 18. Also, a network host 12 in the network pathway 18 provides the connection between the user system and the remote site(s) 16.

Although FIG. 1 demonstrates a particular layout of integrated health information system, the scope of the present invention also anticipates other variations of the system to provide for information transfer. Any number of portable healthcare devices may be in communication with any number of remote information sites through any number of access points, including no access points, leading to one or more access servers, which may be arranged in various fashions within the network environment. An integrated health information system may also include any number of network pathways. Furthermore, a network host may communicate with one or multiple credential services having particular updated credential information that the user system desires. In one embodiment, the access server and/or network host may further be shared by various other user systems.

The user system 4, e.g. a clinic, hospital, office, etc., includes at least a wireless internal network for the portable healthcare device or a group of portable healthcare devices. The user system may incorporate a wireless local area network (LAN) through which the components communicate. The user system may also include a wired internal network that communicates with the wireless internal network.

Through a wireless link within the user system, the portable healthcare device 6 provides for transmission and/or receipt of information. A health professional may use the portable healthcare device during the course of performing daily tasks, such as caring for a patient while simultaneously sending and/or obtaining health-related information “on the fly”. The portable healthcare device conveniently connects a health professional to sources outside of the user system, e.g. a remote information site, in real-time such that the transaction appears to the healthcare professional to be instantly performed and with minimal interruption to the professional. In some cases, the health professional may use the portable healthcare device to send a request for specific health-related information from the remote information site and if the user passes the identity and verification tests, the user may very quickly, e.g. within a few seconds or less, receive the requested information from the remote information site in response. The healthcare professional experiences the transaction in real-time due to the rapid turn around time.

The wireless portable healthcare device 6 may include a variety of devices that are easily moveable or mobile and that may submit and/or receive health-related information in electronic form via a network that is at least partially wireless. The portable healthcare device is usually a handheld computer that is of sufficient size to be used while a person is carrying it and often to be conveniently stored in a pocket.

The portable healthcare device is an intelligent wireless device, such as a personal digital assistant (PDA), e.g. the iPAQ® Pocket PC (from Compaq Computer Corporation, located in Houston, Tex.) and Jornada® (from Hewlett-Packard Corporation, located in Palo Alto, Calif.); a wireless telephone (e.g. cellular, personal communications services (PCS), etc.), a wearable computer, a pager, a BlackBerry™ (from Research in Motion, Ltd., located in Ontario, Canada) or other wireless intelligent device that is portable and may additionally have specific components for use in the integrated health information system. The device may be a wireless, portable computer system, such as a laptop, pocket computer, etc., e.g. a personal computer (PC), such as an Omnibook® (from Hewlett Packard Corporation, located in Palo Alto, Calif.), Vaio® (from Sony Electronics, Inc., located in Park Ridge, N.J.), Powerbook® (from Apple Computer, Inc., located in Cupertino, Calif.), etc. The devices listed are by way of example and are not intended to limit the choice of apparatuses that are or may become available in the portable wireless communications device field that may send or receive information without the need for wires or cables to transmit information, as described herein.

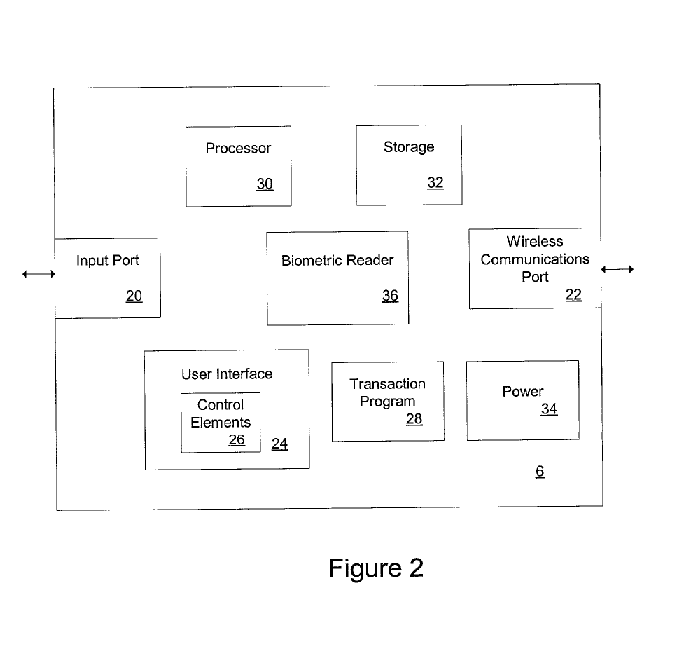

FIG. 2 depicts one embodiment of a portable healthcare device 6 having a wireless communication port 22 to forward data to and receive data from components of the user system, e.g. the access server, access point(s) and/or other components along the network pathway. For example, the wireless communication port 22 may send a request for a transaction, health-related information, or biometric data into the wireless portion of the network pathway, which may be passed either directly to an access server or through at least one access point that in turn transmits the information to the internal network for receipt at the access server.

The wireless communication port 22 communicates with the next receiving point, e.g. access point or access server, in the network pathway through a wireless communication segment of the pathway. The wireless communication port 22 may communicate through carrier-based transmissions, such as infrared radiation or radio frequency (RF), usually according to any of the numerous communication standards used in the telecommunication industry. A common standard protocol is the IEEE 802.11b (Institute of Electrical and Electronics Engineering, std. 802.11b, published by IEEE, September 1999), WiFi™, Bluetooth, etc. In addition, various protocols may be used by the portable healthcare device to communicate within the user system, such as a network layer (Open Systems Interconnection (OSI) standards established by the International Standards Organization (ISO).

The portable healthcare device 6 also includes an input unit 20 to enter health-related information that is to be sent to an access server. In some cases, the health-related information entering the system may be in a raw format, such as digital electronic signature data, fingerprint image data, eye image data, voice patterns, facial patterns, and hand measurements, other biometric authorization data, or the like, or combinations thereof. The biometric data usually includes characteristic points that are used in data comparison when a user tries to gain access to the system and conduct a transaction. This raw format data may require further processing by the portable healthcare device, access server or other component of the user system. In other cases, the data is in a format that is useable by an access server and/or remote information site.

A biometric reader 36 gathers the biometric data and creates biometric data from detected characteristics. The biometric reader converts the scanned data into digital form so that it may be processed by the devices on the network and sent through the network pathway. The biometric reader may also be coupled to a user interface 24, e.g. a scanning surface, for electronically sensing the user characteristics. The user interface 24 may be an integral part of the biometric reader 36 or be a separate component and feed the data into the biometric reader 36. Gathering of biometric data usually requires little intrusion for a user. Furthermore, usually the reader only collects biometric data from “live” personal interaction with a user interface 24. Therefore, there is a high likelihood that the data is fed into the reader by the person who owns the characteristics being analyzed. There are a variety of biometric reader types that acquire data related to different user characteristics.

One type of biometric reader gathers data from an individual's fingerprint. Closely associated with fingerprint biometrics is another biometric reader that registers the imprint left by the palm of the hand. These types of hand readers measure the geometry of the hand rather than the fine skin patterns as found in the fingertip.

Two common types of optical biometric readers are retina and iris recognitions. Retinal and iris biometric devices may be used for high accuracy determinations because both the retina and iris have more characteristics to identify and match than some other body parts, such as those found on the hand.

Facial biometric readers examine overall facial structure of a user. Some facial readers, may incorporate a neural network approach or other compensation technology to consider different head orientations, lighting, makeup, suntan, facial hair, facial expressions, glasses, hairstyles, etc, in order to improve accuracy.

Another biometric reader recognizes a user's voiceprint. Such voice readers may include a mechanism that takes into account variations in voiceprints over the course of the day, and according to a user's health, such as changes due to a cold or laryngitis for improved accuracy.

Biometric readers may also include signature recognition devices, which may measure the height and width of pen strokes. Some signature recognition systems also consider an amount of pressure applied in the pen stroke as compared to the depth that would occur if the stroke were made in the air. Signature recognition readers may also take into account that users may not always sign documents in exactly the same manner, for example, variations due to different angles at which the user signs due to seating position or hand placement on the user interface surface.

Other biometric readers may recognize keystrokes for the correct password and also the rate of typing and intervals between letters to gain access to the information. It is most likely that, even if an unauthorized person is able to guess the correct password, they will not be able to type it with the proper rhythm unless they have had the ability to hear and memorize the correct users keystrokes.

All of the biometric readers described herein are by way of example and are not intended to limit the choices that are or may become available in the art for detecting various user characteristics.

The user interface 24 may also be for presenting to the user such as on a display screen, health-related information that arrives at the portable healthcare device or capturing health-related information departing from the device. The transfer of health-related information from across the network pathway and the presentation of information occur in real-time from the time the information leaves the remote information site and arrives at the user interface. Furthermore, the user interface may be for generating health-related information for transfer through the network pathway. The user interface 24 may be an audio interface, e.g. microphone, speaker, etc.; a visual interface, e.g. display; and/or a kinesthetic interface e.g. contact sensitive surface, deformable surface, etc. The user interface may also be coupled to the input port 20 for entering information to the portable healthcare device. The input port may also directly connect to a health-related information source. The user interface may include one or more control elements 26 to generate health-related information.

There are various types of control elements 26 that may be include in the user interface. One type of control element is visible through an optional display screen (e.g. a liquid crystal display) that may be integrated with the portable healthcare device or coupled to the device. Such control elements may include buttons, pop-up or pull-down menus, scroll bars, iconic images, and text entry fields. The visual control elements may be activated by a variety of mechanisms, such as a touch pad, touch screen, pen-to-text data entry device, or activation mechanisms present on input/output devices, such as a keyboard and/or a mouse. Other control elements may be invisible to a display, such as voice or audio recognition elements, optical recognition elements, touch responsive elements, etc. There are a variety of interactive mechanisms to activate invisible and/or visible controls, such as voice or audio commands, touch movement or imprints, network signals, preprogrammed triggers within the system, instructional input from other applications, etc.

One or more health transaction software program(s) 28 may provide prompts for the user to input desired transaction parameters, biometric data, and the like, through the user interface. For example, the transaction program may provide a list of types of health-related information for the user to request. The transaction program may also provide prompts for the user to submit patient information related to particular health-related information. The portable healthcare device may deliver numerous health-related transactions through various software packages, such as TouchWorks™ (from Allscripts Healthcare Solutions, located in Illinois).

The portable healthcare device 6 also includes processor 30, which may represent one or more processors to run an operating system and applications software that controls the operation of other device components. Some examples of processors are a StrongARM™ processor (from Intel Corporation, located in Santa Clara, Calif.), a Motorola® Power PC processor (from Motorola, Inc. located in Chicago, Ill.), etc.

A storage unit 32 is provided to hold data related to an operating system, applications, application data, and/or transaction-related data. The storage unit 32 may be any electrical, magnetic, optical, magneto-optical, and/or other type of machine-readable medium or device for writing and storing data. For example, the storage unit 32 may be one or more magnetic disks, FLASH memory, random access memory (RAM), such as dynamic RAM (DRAM) and static Ram (SRAM), etc. The amount of storage required depends on the type and amount of data stored.

Often a non-volatile storage, e.g. electrically erasable programmable read only memory, FLASH memory, or cache, is provided for the operating system and resident software applications. The storage unit may also be a hard drive, either integrated within the system, or external and coupled to the system. The storage unit may also be coupled to other types of multiple storage areas that may be considered as part of the storage unit or separate from the storage unit. These storage units 32 described are by way of example and are not intended to limit the choice of storage that are or may become available in the data storage field, as described herein.

A power unit 34 is included with the portable healthcare device to supply energy used to operate the device components. In one embodiment, the power unit 34 may be an energy storage area to hold power, which may be integrated into the device or removable and capable of being inserted into the device. For example, the power unit 34 may be a battery that is charged by energy from an external source. In another embodiment, the power unit 34 may be simply a power connector to direct energy from an external power source to the various device components rather than to store energy.

Furthermore, the portable healthcare device may also have various optional components, such as other security measures in addition to the biometric data reader to ensure permitted access to the internal network, protect transferred data, and the like. Security may be provided through encryption and/or authorization tools.

The transmission exiting from the portable healthcare device may pass through one or more access points(s) 8, e.g. wireless LAN access point(s), that serve as a bridge between the access server and/or an existing wired network and the wireless device. The access point may also act as a router to pass along transmissions from one access point to another. One such access point is Intel PRO/Wireless 2011 LAN Access Point (by Intel Corporation, located in Santa Clara, Calif.).

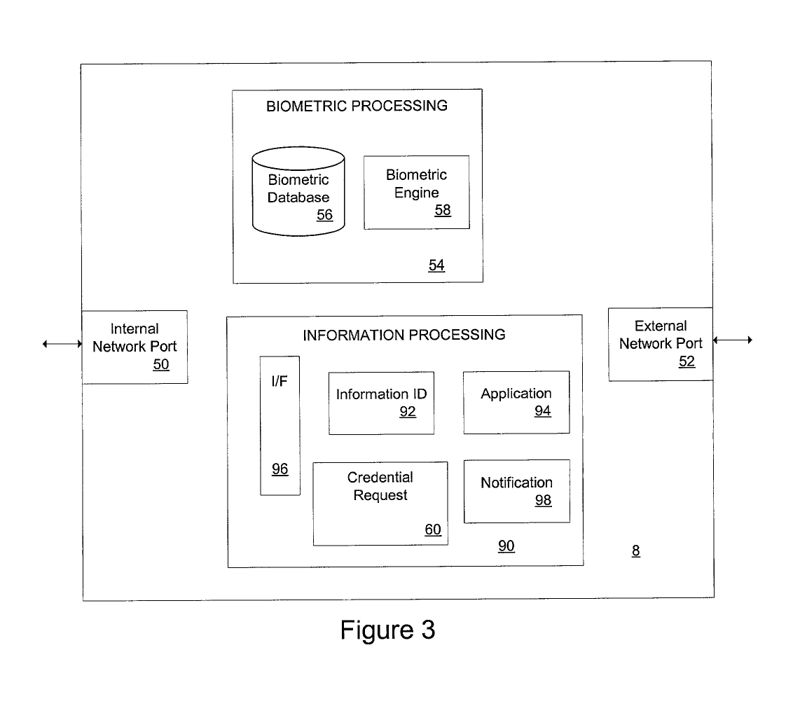

The access server 8 functions as an interface for all communications leaving and entering the user system to conduct any necessary processing and translations on the transmissions and determine verification of the user. One embodiment of access server 8 in the user system is shown in FIG. 3. An internal network port 50 receives communication, e.g. health-related information promulgated from the portable healthcare device, of the internal network of the user system. Furthermore, the access server has an external network port 52 to transport and accept communications with a remote information site, such as through a network host.

A biometric processing unit 54 is provided in the access server to perform biometric authentication of a user by considering submitted biometric data received for a portable healthcare device. Biometric authentication involves the measurement and statistic analysis of a user's body characteristics, body parts, movement, voice, etc., in the form of biometric data. A biometric database 56 stores authentication data that may be used for comparison with submitted biometric data when a user attempts to gain access, e.g. transaction request.

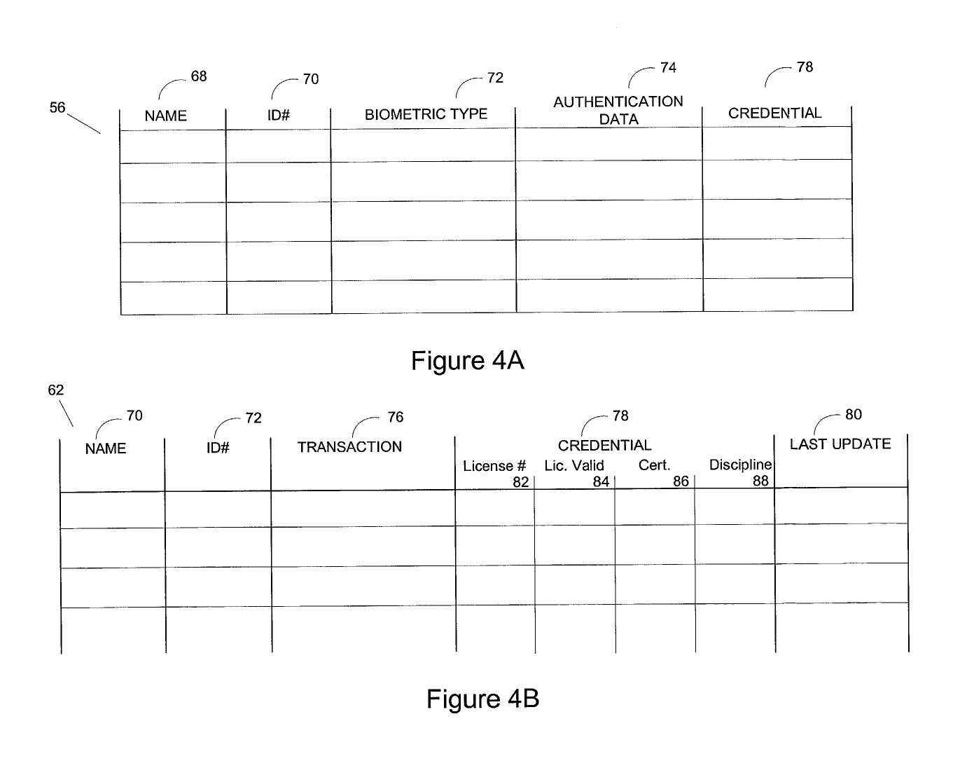

One example of a biometric database 56 is depicted in FIG. 4A having a name field 68 for the user's name and identification number field 70 to denote a number that designates the user. The biometric database may also include a biometric type field 72 to specify the type of authentication data contained within the corresponding authentication data field 74. Types of authentication data may include fingerprint data and may further specify the finger and hand of the user; retina or iris data and may also denote which eye of the user; handprint and may identify the user's left or right hand; facial image; voiceprint data; signature data; keystroke data; and the like; or combinations thereof. Each authentication data is biometric data that is usually entered prior to a requested transaction and is accurate to identify a characteristic of the user. A credential field 78 may also be included to contain credential information that serves as enabling information for release to a user upon verification.

A biometric engine 58 retrieves from the biometric database the authentication data that corresponds to the person the user claims to be and compares it with submitted biometric data from a portable healthcare device when a user tries to gain access, e.g. by requesting a transaction. Any number of characteristic points in the stored authentication data may be used for the comparison. Using an algorithm, the characteristic points are processed into a value that can be contrasted with submitted biometric data gathered when a user tries to gain access. The appropriate authentication data may be located through input of a user name, identification number, or other notation that cross-references the authentication data listed in the biometric database for a user. At least an established minimum of the submitted biometric data must match the corresponding stored authentication data, for the user's identity is to be confirmed. The higher the required percentage of matches, the higher the security level provided by the system.

The access server may require that a user submit biometric data with each transaction requested or with each user login. In some embodiments, the biometric data may be required to be resubmitted after a period of time of non-use of a portable healthcare device, e.g. every 2 minutes.

The access server 10 has information processing components 90 for processing health-related information for sending through the network pathway. The also information processing components 90 includes a credential request unit 60 to determine whether the user has the proper credentials to perform a requested transaction, such as by requesting that a credential service 40 perform a check of credential information. The credential check may be related to the user in general, or to both the user and a transaction requested by the user. Typically, credential information is only considered if the user's identity is first verified to be correct. Otherwise, if the submitted biometric data is not recognized, i.e. no match of data, usually the user system does not proceed with determining validity of credential information, e.g. requesting a credential check.

For example, where a user logs in to initiate a session, the credential request unit may send for a credential check. In some embodiments, the access server may automatically end a session and require a credential check after a pre-designated period of time by the user resending login information to initiate a new session. For instance, login may be required after a time of inactivity by the user with the portable healthcare device, e.g. 2 to 10 minutes.

Such a credential check request that is transferred by the network host to the credential service includes the name of the user, user identification and/or other information that enables the credential check to recognize the appropriate user credential information. In addition, the request may include the type of transaction that the user wishes to perform. In response to sending the check request, the credential request unit 60 may receive credential check results from the credential service.

The credential request unit 60 may also determine validity of credential information by ascertaining whether there is corresponding credential information for a specific transaction stored in the credential database. For instance, where a user has already logged into a session and the credential information was checked for accuracy through a credential service during the current session, the credential engine may simply make certain that the previously checked credential information for the session still applies to the presently requested transaction. If the previously checked credential information does not apply, the credential engine may send a request for a credential check to the credential service, as described above.

The information processing components 90 may also include a notification unit 66 to inform the user of the portable healthcare device of the status of its request. For example, where authorization for the request for a health-related transaction has failed, e.g. where biometric data is inaccurate or no sufficient credential information is found, the notification unit may send a message that the transaction is denied. Furthermore, the notification unit may send a signal to indicate that the transaction is being processed. In addition, the notification unit 66 may transmit a notice that biometric data must be entered for a transaction to be authorized.

In some cases, the notification unit 66 may send a requirement for the login information to the portable healthcare device after a pre-designated time period of inactivity. For instance, where a session has been activated and no transaction has been requested within a period of time, e.g. 2 to 10 minutes, the user may be automatically logged out of the current session and the user must resend login information in order to perform a transaction.

Further to the information processing components 90, an information identification unit 92 may be included to inspect information received from the network pathway and determine the type of the information. Furthermore, a server interface 96 is for preparing the health-related information to be in a suitable format for the next segment of the network pathway to receive the information.

The identification unit 92 may determine to where the information should be transferred along the network pathway. Such a determination may be made referencing an original request for the health-related information or as specified in the transmission unit. The receiving destination may be a requesting portable healthcare device, some other portable healthcare device, a designated electronic device or computer, a network host, a access point, a remote information site, a next segment toward a particular second end of the network, etc. In one embodiment, the information identification unit 92 may recognize the received information as a response to an earlier requested transaction or as a new transaction. For instance, the access server may maintain a log of references to requested transactions and the identification unit compares the incoming information with the references in the log.

Furthermore, the access server 10 may include an application unit 94 to determine the software application program to which the information belongs to and how the information should be entered into the appropriate application. The information may be associated with an application that is specific for the remote information site that sent it or multiple remote sites may be supported by one application program. In addition, a storage verification unit may be provided to ascertain whether the access server is to store the health-related information. Such storing of health-related information may be made in addition to transferring the information to a user, or in lieu of such transfer.

The access server usually also includes some conventional server components as known in the field. For example, a processor for controlling the other server components, and a storage unit for storing programs and data may be provided.

In still other embodiments of an access server, various other optional components may be present in the access server, which assist in transfer of health-related information. The access server may have a back-end processing unit for providing back-end services or support for a front-end application running on a portable healthcare device or other component of the user system. Such back-end processing unit may process raw health-related information generated by the portable healthcare device. For example, a speech recognition engine may be included to convert speech data collected by the portable healthcare device.

In addition, the access server may include various network components for encrypting data, for encapsulating data and for detecting and reacting to latency changes in network traffic.

The user system communicates with a network host 12 through external network 14. The network host 12 is the hub for all transmissions traveling to and/or from a user system, remote site 16 and credential service.

Credential service 40 communicates with the access server 10, usually through the access server's external network port 52 to perform credential processing upon receipt of a credential check request from the access server of a user system. The credential service 40 is remotely located from the user system 4. The credential service is able to provide results of a credential check to the access server, via the network host, immediately upon receiving a request for the check.

The credential service tracks the level of capability for a user to perform a transaction or to practice in a field. Usually, the credential service has credential information that is relatively up to date and more current than credential information at a remote information site. For example, the credential service may maintain current credential information that relates to whether a user has a valid license to practice in a particular health field. The credential service may also have information on whether a user has the appropriate credentials that are required for a particular transaction.

One example of a credential database 62 is depicted in FIG. 4B. The name field 68 is for the user's name and identification number field 70 is to denote a number that designates the user. In some embodiments, a transaction type field 76 may be included to specify the kinds of transactions that are covered by the corresponding credential information listed in the credential information field 78. For example, transactions requiring a specialty area of expertise may require particular certifications in the credential information. In other embodiments, no type field 76 is included and the credential information field 78 is for specifying all credential information for any transaction type. Optionally, there may be a field to indicate when the credential information was last updated 80.

The credential information in the credential database 62 may be retrieved from a licensing establishment or other storage center for credential information. Numerous types of credential information may be stored in the credential database. For example, some credential information may include a professional license number field 82 to denote the user's license number, a valid field 84 to signify if the license is current, a certification field 86 to list particular certifications the user has achieved and a disciplinary field 88 to specify whether the user is restricted to practice according to any disciplinary actions, etc. The credential service determines validity of credential information associated with the user by accessing the stored credential information in the credential database and generates check results based on its findings.

The check results provided by the credential service is information that facilitates the access server to permit a user transaction or reject the transaction. In one embodiment, the results of the credential check may include a positive response that the credential information has cleared and the user may perform the transaction or a negative answer that the credential information indicates that the user does not have the proper credentials to carry out the transaction. The check results are transferred to the network host, which transmits the information to the appropriate user system.

The network host communicates with the user system and various remote sites through external network 14. The external network 14 is a public network (e.g. the Internet), a network that runs over a public network and provides for tunneling of data packets (e.g. a virtual private network (VPN)), or private (e.g. dedicated leased communication line, which may only be used by one user system and remote information site) network. Usually, the network provides for security in transport, as in a VPN where special encryption is used at the sending end and decryption at the receiving end.

During a transaction, one or more remote information site 16 may communicate health-related information in electronic form with various components of the user system and/or receive health-related information, from across the respective network pathway. Often, the remote information site retains health-related information, may create the information immediately upon receiving a request, or has ready access to the health-related information stored elsewhere, for performing a transaction. The remote information site is capable of providing responses during a transaction in real-time through the integrated health information system of the present invention.

Oftentimes, the remote information site is an application service provider (ASP) or similar back-end service center that collects data, acts upon the data and sends the data to a user system. The remote information site may be a healthcare clearinghouse that processes or facilitates the processing of data elements of health-related information. A health planner may also serve as a remote information site that provides, or pays the cost of, medical care, e.g. through an individual plan or group health plan. The information site may be a PBM, prescription service, prescription refill service, testing lab, transcription company, etc. For example, a PBM may have certain health-related information for use in determining whether an insurance plan or HMO should cover a prescription. Usually, there are a variety of remote information sites connected to the network pathway.

The present process of verifying a user for a transaction permits real-time transactions, whereas with previous system the remote site may have interrupted the course of a transaction to conduct a credential check prior to responding to the transaction. Typically, a remote site does not maintain current credential information and, without employing the present system, the query of a credential service by a remote site while performing the transaction process is often time consuming and the transaction may not be performed in real-time for the healthcare professional.

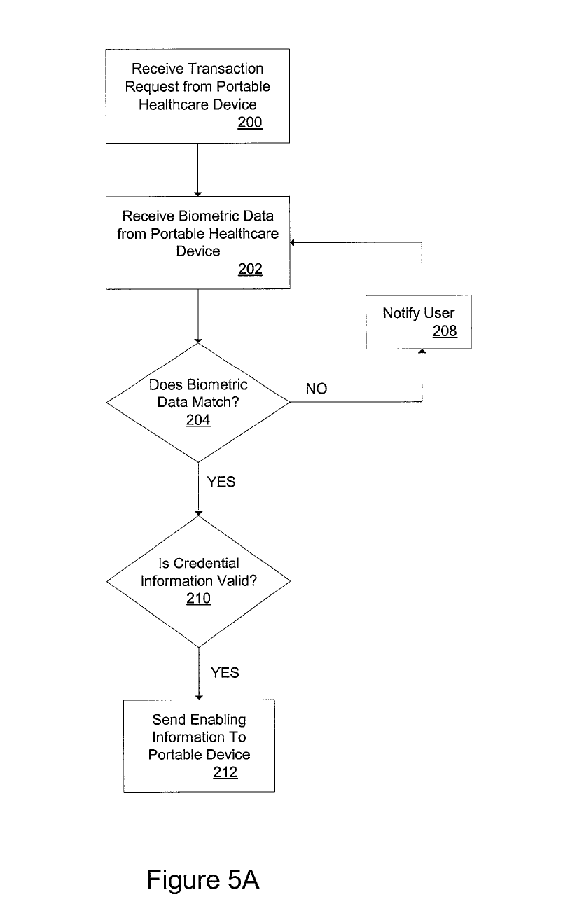

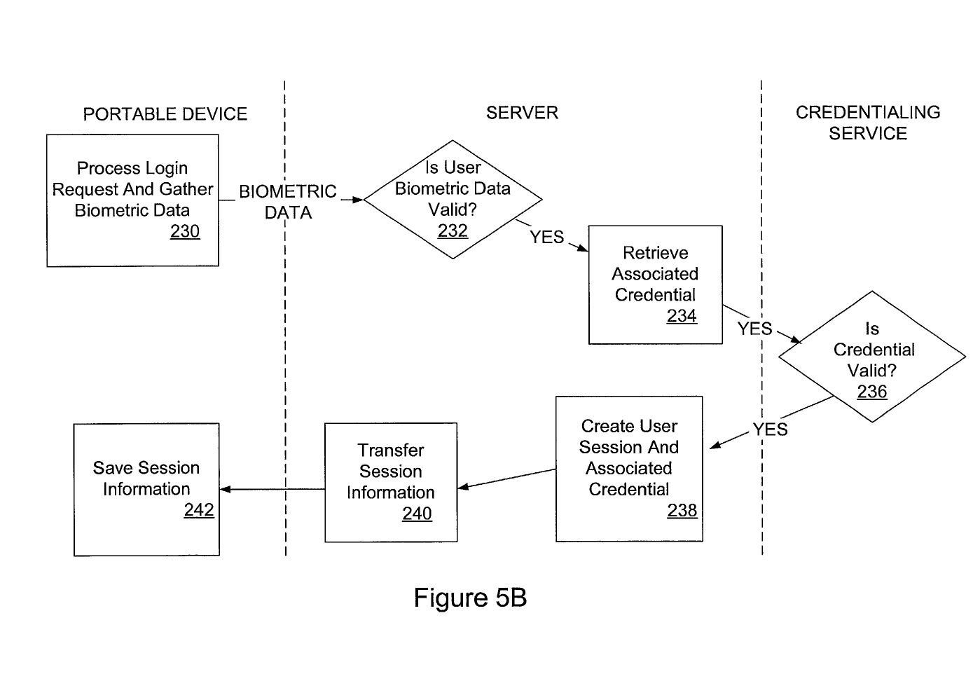

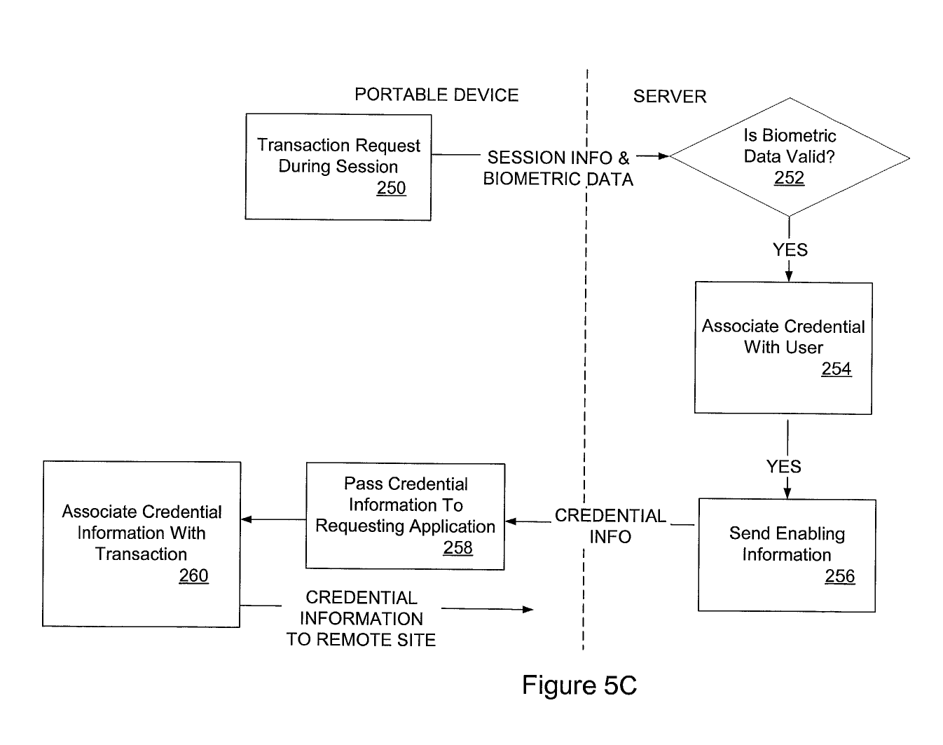

FIG. 5A shows one embodiment of a process to verify a user for a transaction, according to the present invention. The access server receives a request for a transaction from a portable healthcare device of the pathway 200 and a determination is immediately made as to whether permission is to be granted for the transaction. The access server receives biometric data from the portable healthcare device 202 and determines whether the submitted biometric data matches stored authentication data for the user 204. If the biometric data does not match, a notification failure is sent to the user 208 and the user may resubmit the biometric data 202. The process does not continue to consider credential information unless it is determined that biometric data is authentic and the user is confirmed.

Where the biometric data does match stored authentication data, the stored credential information associated with the user and/or transaction is returned by the biometric authentication. A determination is made as to whether the credential information is valid 210. This determination may entail requesting a credential service perform a credential check. If it is valid, enabling information is sent to the portable healthcare device that made the request for the transaction 212. If there are more requests for transactions, the process may repeat for each request. In the alternative, the process may be only conducted for an initial login to create a session.

The enabling information is any information that permits the portable healthcare device to perform a particular transaction with a remote information site. The enabling information may comprise session information where a new session is being initiated, such as the user logging into the system. Furthermore, the enabling information may comprise current credential information that is stored at the access server and/or provided by the credential service. Oftentimes, credential information may be sent as the enabling information where a remote site requires such information.

The user verification process may occur during user login, as shown by one embodiment in FIG. 5B in the context of the portable healthcare device, access server and credential service. The portable healthcare device receives a request for logging into a new session, such as from the user or the access server 230. Simultaneously or immediately afterwards the device gathers biometric data for the user 230. The biometric data is sent to the access server, which processes the biometric data to determine if the data is valid 232. Where the biometric data is valid, the access server retrieves the credential information associated with the user 234. The credential service determines if the credential information is valid, i.e. the user may perform the transaction 236. Where the credential information for the user is found to be valid, the access server creates session information and associates the credential information with the session 238. The enabling information, including session information, is transferred to the portable healthcare device 240 and the portable healthcare device saves the session information 242.

The user verification process may occur when one or more transaction is requested during a session, as shown by one embodiment in FIG. 5C in the context of the portable healthcare device and access server. The portable healthcare device generates a request for a transaction during a currently open session, according to instructions from a user 250. The portable healthcare device sends session information and biometric data to the access server. The access server determines whether the biometric data is valid to suggest that the current user is authentic 252. If the biometric data is valid, then the access server proceeds to associate the credential with the user 254, e.g. as associated during previous login to the session 238. The enabling information, including the credential information, is sent to the portable healthcare device 256. The portable healthcare device passes the credential information to the appropriate application to use the information 258, e.g. to process the credential information for sending to a remote site that requires the information for the transaction. The credential information is associated with the requested transaction in order to conduct the transaction 260 and the credential information is forwarded to the remote site, e.g. to the access server and through the network pathway.

From the time a portable healthcare device requests a transaction, permission is rapidly processed and if permission is granted, enabling information is quickly sent, a first end of the pathway submits the health-related information related to the transaction, and the information swiftly flows through all segments of the network pathway. All steps of the process are instantly performed to achieve fast turn-around time, e.g. within a few seconds of time, and retrieval of information, i.e. in real-time for healthcare professional.

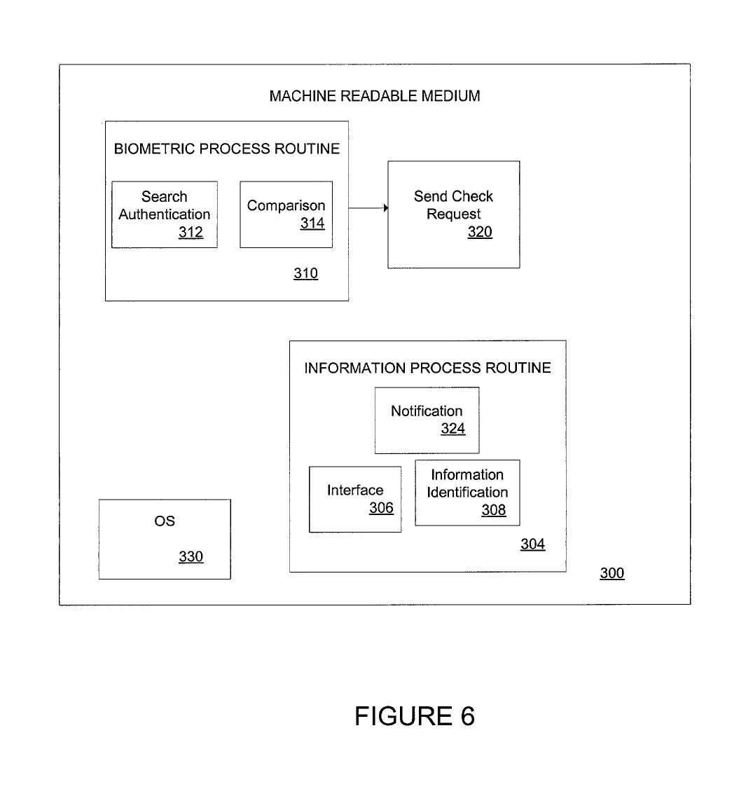

Various software components, e.g. applications programs, may be provided within or in communication with the access server that cause the processor or other components of the server to execute the numerous methods employed in conveying information through a network pathway. FIG. 6 is a block diagram of a machine-accessible medium storing executable code and/or other data to provide one or a combination of mechanisms for verifying a user to perform a health-related transaction, according to one embodiment of the invention.

The machine-accessible storage medium 300 represents one or a combination of various types of media/devices for storing machine-readable data, which may include machine-executable code or routines. As such, the machine-accessible storage medium 300 could include, but is not limited to one or a combination of a magnetic storage space, magneto-optical storage, tape, optical storage, battery backed dynamic random access memory, battery backed static RAM, FLASH memory, etc. Various subroutines may also be provided. These subroutines may be parts of main routines in the form of static libraries, dynamic libraries, system device drivers or system services. The processes of various subroutines, which when executed, are described above with regard to FIG. 5A.

The machine-readable storage medium 300 is shown having a receive information routine 302, which, when executed, obtains a request for a transaction, biometric data, health-related information, etc. from across a network.

A biometric processing routine 310 is for processing biometric data submitted from a user. This routine involves a search biometric subroutine 312 for searching and pulling appropriate authentication data from a database. A comparison subroutine 314 is also provided for determining whether submitted biometric data matches stored authentication data. Where a match is found, the biometric processing routine may indicate to the send check routine 3204 that credential should be verified. The send check request routine 320 conveys a request to a credential service to perform a credential check for the user and/or user in the context of the transaction desired by the user.

During a transaction, incoming health-related information may be immediately passed to an information processing routing 304. The information processing routine 304 is for processing the receive information through various subroutines. An interface subroutine 306 is for preparing the health-related information with appropriate data for reading at the next segment. An information identification subroutine 308 may be executed for identifying the information and/or determining the appropriate next segment to receive the information. A send information routine 310 includes instructions for sending the processed information, in the form of transmission unit(s) into the network towards its ultimate destination. Furthermore a notification subroutine 324 may be provided to send a notice to segments of the network pathway.

In addition, other software components may be included, such as an operating system 330.

The software components may be provided in as a series of computer readable instructions. When the instructions are executed, they cause a processor to perform the steps as described. For example, the instructions may cause a processor to accept information, process the information, forward the information, etc.

The present invention has been described above in varied detail by reference to particular embodiments and figures. However, these specifics should not be construed as limitations on the scope of the invention, but merely as illustrations of some of the presently preferred embodiments. It is to be further understood that other modifications or substitutions may be made to the described integrated health information system as well as methods of its use without departing from the broad scope of the invention. The above-described steps of transacting through a real-time healthcare network pathway may be performed in various orders. Therefore, the following claims and their legal equivalents should determine the scope of the invention.

What is claimed is:

1. A method of verifying a user in a health-related transaction, the method comprising:
receiving a request from a portable healthcare device to perform a health-related transaction in real-time across a network pathway from the portable healthcare device to a remote information site;
receiving biometric data from the portable healthcare device;
determining whether corresponding biometric data is stored;
if corresponding biometric data is stored, determining validity of credential information associated with a user; and
if the credential information is valid, sending to the portable healthcare device, enabling information for performing the health-related transaction.

2. The method of claim 1, wherein the request includes login information to initiate a session and the enabling information includes session information.

3. The method of claim 2, wherein the determining of validity of credential information includes sending a request for a credential check to a credential service and receiving a credential check result from the credential service.

4. The method of claim 2, further including requiring the login information after a pre-designated time period of inactivity.

5. The method of claim 1, wherein the enabling information includes the credential information for forwarding to the remote information site.

6. The method of claim 5, wherein the determining of validity of credential information includes comparing the credential information to previously determined credential information for a current session.

7. The method of claim 1, wherein the biometric data includes voice data, digital electronic signature data, fingerprint image data, or eye image data.

8. The method of claim 1, wherein if corresponding biometric data is not stored, further including denying the requested health-related transaction.

9. The method of claim 1, wherein the receiving biometric data occurs at pre-designated intervals of time.

10. A system for verifying a user in a health-related transaction, comprising:
a) a biometric database to store biometric data;
b) a biometric engine to determine whether corresponding biometric data is stored in the biometric database for a user of a portable healthcare device requesting a health-related transaction in real-time across a network pathway from the portable healthcare device to a remote information site;
c) a credential request unit to determine validity of credential information associated with the user if corresponding biometric data is stored; and
d) an internal network port to receive the request for the health-related transaction from the portable healthcare device and to send enabling information for performing the health-related transaction to the portable healthcare device if the credential information is valid.

11. The system of claim 10, wherein the request includes login information to initiate a session and the enabling information includes session information

12. The system of claim 11, further including an external network port to send a request for a credential check from the credential request unit to a credential service and receive a credential check result from the credential service.

13. The system of claim 10, further including a notification unit to send a requirement for the login information after a pre-designated time period of inactivity.

14. The system of claim 10, wherein the enabling information includes the credential information for forwarding to the remote information site

15. The system of claim 14, wherein the credential request unit is to compare the credential information to previously determined credential information for a current session.

16. The system of claim 10, wherein the biometric data includes voice data, digital electronic signature data, fingerprint image data, or eye image data.

17. A computer accessible medium having stored therein a plurality of sequences of executable instructions, which, when executed by a processor, cause the system to:
receive a request from a portable healthcare device to perform a health-related transaction in real-time across a network pathway from the portable healthcare device to a remote information site;
receive biometric data from the portable healthcare device;
determine whether corresponding biometric data is stored;
if corresponding biometric data is stored, determine validity of credential information associated with a user; and
if the credential information is valid, send to the portable healthcare device, enabling information for performing the health-related transaction.

18. The computer accessible medium of claim 17, wherein the request includes login information to initiate a session and the enabling information includes session information.

19. The computer accessible medium of claim 18, wherein the determining of validity of credential information includes sending a request for a credential check to a credential service and receiving a credential check result from the credential service.

20. The computer accessible medium of claim 18, further including additional sequences of executable instructions, which, when executed by the processor further cause the system to require the login information after a pre-designated time period of inactivity.

21. The computer accessible medium of claim 17, wherein the enabling information includes the credential information for forwarding to the remote information site.

22. The computer accessible medium of claim 21, wherein the determining of validity of credential information includes comparing the credential information to previously determined credential information for a current session.

23. The computer accessible medium of claim 17, wherein the biometric data includes voice data, digital electronic signature data, fingerprint image data, or eye image data

24. The computer accessible medium of claim 17, further including additional sequences of executable instructions, which, when executed by the processor further cause the system to interrupt a processor to deny the requested health-related transaction if corresponding biometric data is not stored.

25. The computer readable medium of claim 17, wherein the receiving biometric data occurs at pre-designated intervals of time.

26. A method of verifying a user in a health-related transaction, the method comprising:
receiving a request from a portable healthcare device to perform a health-related transaction in real-time across a network pathway from the portable healthcare device to a remote information site, the request including login information to initiate a session;
receiving biometric data from the portable healthcare device;
determining whether corresponding biometric data is stored;
if corresponding biometric data is stored, determining validity of credential information associated with a user comprising sending a request for a credential check to a credential service and receiving a credential check result from the credential service; and
if the credential information is valid, sending to the portable healthcare device, enabling information for performing the health-related transaction including session information for performing the health-related transaction.

27. The method of claim 26, further including requiring the login information after a pre-designated time period of inactivity.

28. The method of claim 26, wherein the enabling information includes the credential information for forwarding to the remote information site

29. The method of claim 26, wherein the biometric data includes voice data, digital electronic signature data, fingerprint image data, or eye image data.
